(19) United States
(12) Patent Application Publication
(10) Pub. No.: US 2006/0184373 A1
(43) Pub. Date: Aug. 17, 2006

(54) Method and system for quick and automatic police canvas operation of an identified crime scene area using an autodialer

(75) Inventor: David Bruce Kumhyr, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/050,603

(22) Filed: Feb. 3, 2005

(51) Int. Cl. G06Q 99/00; G08B 13/00; G06F 9/44; G08B 19/00

(52) U.S. Cl. 705/1; 340/574; 705/7; 340/521

(57) ABSTRACT

A data processing system to automatically canvass for witnesses within an identified crime scene area. After an incident report is received, the locus and boundary of the crime scene is determined. Telephone calls are automatically initiated to a list of compiled telephone numbers within the boundary of the identified crime scene area. Responses to the automatically initiated telephone calls are then logged or transferred to a police operator.

### BACKGROUND OF THE INVENTION

1. Technical Field

The present invention relates generally to an improved data processing system. More specifically, the present invention is directed to a method, apparatus, and computer program product to quickly and automatically canvass an identified crime scene or incident investigation area for potential witnesses.

2. Description of Related Art

The purpose of crime scene investigation is to help establish what happened and to identify the responsible person(s). Actions taken at the outset of an investigation at a crime scene can play a pivotal role in the resolution of a case. Careful, thorough investigation is the key to ensuring potential physical evidence is not tainted or destroyed or potential witnesses overlooked.

Information or statements from witnesses to the crime may become crucial to a successful resolution of a case. Consequently, it is very important for police to find witnesses quickly. Upon arrival at a crime scene, police will establish control and determine boundaries to the incident area. This police action is to protect evidence and to provide a means of identifying potential witnesses.

Officers at the scene will separate witnesses. Witnesses are separated in order to prevent them from talking to one another about the incident. Witnesses talking amongst themselves may contaminate each other's story or account.

It is common knowledge that witnesses to the same incident or crime will have differing accounts. As a result, it is imperative for the police to find the witnesses and obtain the information as quickly as possible to prevent contamination. In addition, the police want the witness' version of the story while it is still fresh in the memory.

Also, it should be kept in mind that not all witnesses may be within the immediate crime scene area when the police arrive. Witnesses may have been passing by in a vehicle at the time of the crime or were viewing the incident at a distance. Or, witnesses that were physically present when the crime occurred, fled the scene for safety reasons or just decided to leave for no reason whatsoever. Therefore, not all witnesses may be immediately accessible to police. However, it is crucial to the investigation that police locate witnesses as soon as possible.

Consequently, police investigators will perform a canvass operation of “a neighborhood” that surrounds the scene of a crime. Canvassing is the process whereby police attempt to locate and identify witnesses who may have useful information about the crime. Currently, the method for canvassing a neighborhood by investigators is to physically go door-to-door asking people to provide information. One problem with going door-to-door is that it is a hit and miss operation, meaning that investigators may not be able to talk to all the witnesses to the crime. For example, a witness may not answer a knock on the door out of fear (fear for one's safety or fear of being seen by others talking to the police). It is common for investigators to leave a business card or possibly a short note at a “no response” door, but the response rate to left business cards and notes is very low. Or, the investigators may accidentally miss a residence during the canvass operation.

Another problem with going door-to-door is that the process is slow and requires a lot of valuable police time and manpower to accomplish the task. Furthermore, investigators will have to take more time out of their schedule to telephone missed residences or residences where no response was obtained to the door knock.

Therefore, it would be advantageous to have an improved method and apparatus to quickly and automatically conduct a police canvass operation for witnesses in an identified crime scene area.

### SUMMARY OF THE INVENTION

The present invention provides a method, apparatus, and computer program product for quickly and automatically canvassing for potential witnesses in an identified crime scene or incident investigation area by police. After an incident report is received, the locus and boundary of the crime scene is determined. Telephone calls are automatically initiated to a list of compiled telephone numbers within the boundary of the identified crime scene area. Responses to the automatically initiated telephone calls are then logged or transferred to a police operator.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is an exemplary block diagram of a data processing system in which a preferred embodiment of the present invention may be implemented;

FIG. 3 is a block diagram illustrating exemplary sources of information that may be utilized by the data processing system in FIG. 2 in accordance with a preferred embodiment of the present invention;

FIG. 4 is a flowchart illustrating a method for automatically canvassing a crime scene investigation area by police in accordance with a preferred embodiment of the present invention; and

FIG. 5 is a specific example of an identified police crime scene area in which a preferred embodiment of the present invention may be implemented.

### DETAILED DESCRIPTION OF THE PREFERRED EMBODIMENT

The present invention is a method, apparatus, and computer program product for quickly and automatically canvassing an identified crime scene or incident investigation area for witnesses by police.

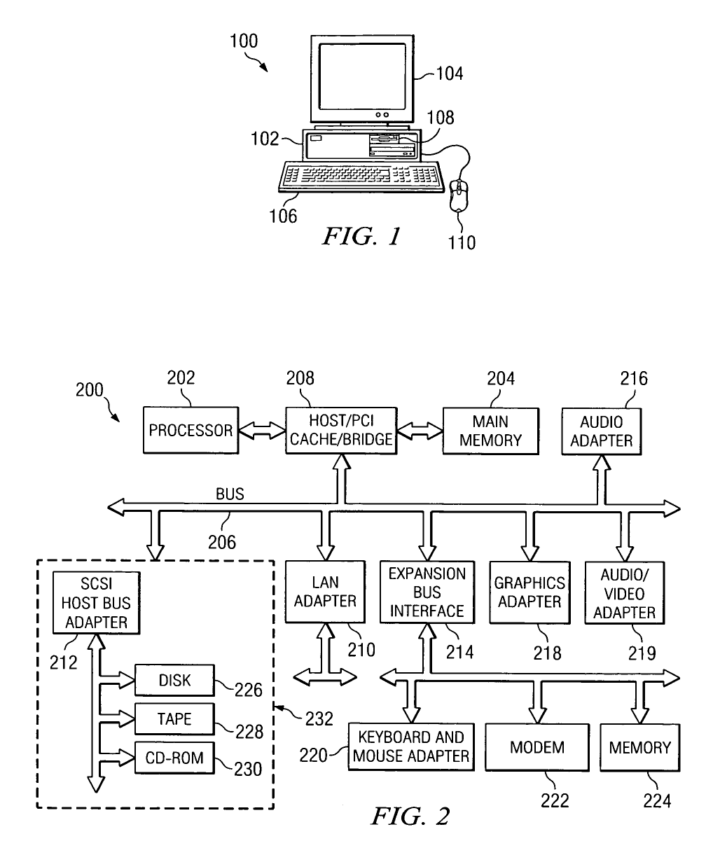

With reference now to the figures, FIG. 1 a pictorial representation of a data processing system in which the present invention may be implemented is depicted in accordance with a preferred embodiment of the present invention. A computer 100 is depicted which includes a system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

Referring now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The present invention provides a method, apparatus, and computer program product for quickly and automatically canvassing an identified crime scene area for witnesses by police. After receiving an incident report, the locus of the crime scene and its boundary are determined. Telephone calls are made to list of compiled telephone numbers within the boundary of the crime scene area automatically. Then responses to the telephone calls are logged or transferred to a police operator.

An advantage of the present invention is the ability of police to quickly and automatically canvass a crime scene area for witnesses. Police utilizing this automated process to perform canvass operations will save critical time and manpower in solving the crime under investigation. As a result of the quick and automatic canvass operation, police are able to locate witnesses faster. Locating witnesses faster will aid police in resolving the case and apprehending the offender sooner.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

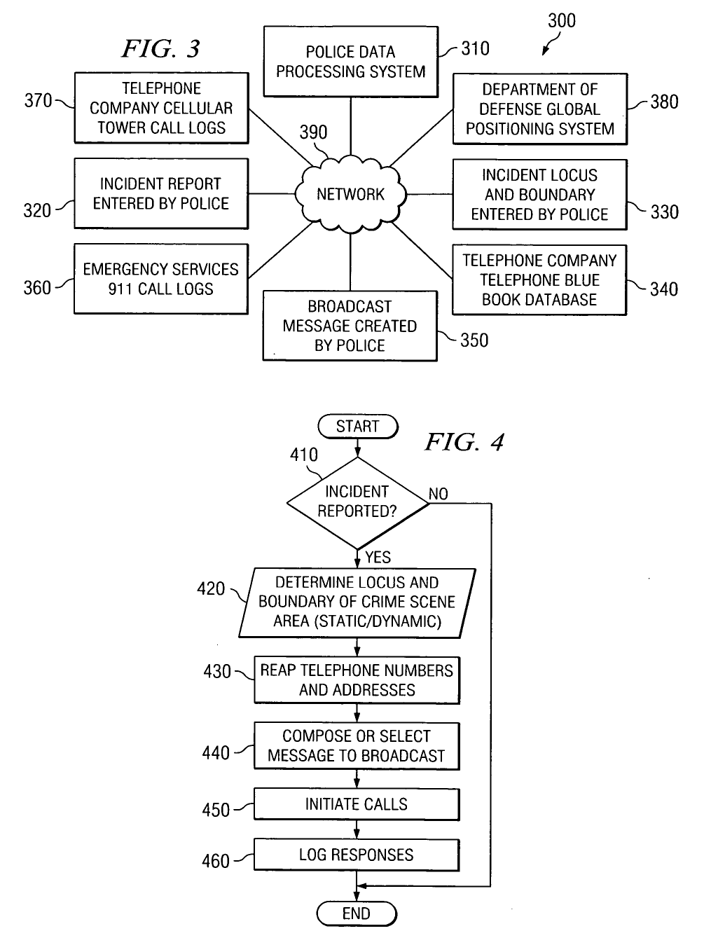

With reference now to FIG. 3, a block diagram illustrating sources of information that may be utilized by data processing system 200 in FIG. 2 is depicted in accordance with a preferred embodiment of the present invention. FIG. 3 represents distributed data processing system 300 in which the present invention may be implemented. Distributed data processing system 300 is a network of computers in which the present invention may be implemented. These computers may be implemented using systems such as data processing system 200 in FIG. 2. Distributed data processing system 300 contains a network 390, which is the medium used to provide communications links between various devices and computers connected together within distributed data processing system 300. Network 390 may include permanent connections, such as wire or fiber optic cables, or temporary connections made through telephone connections. In addition, network 390 may include wireless connections such as microwave, shortwave, wireless fidelity (Wi-Fi), Bluetooth, and the like. Bluetooth is a wireless personal area network (PAN) technology founded in 1998 by Ericsson, IBM, Intel, Nokia and Toshiba. Bluetooth is an open standard for short-range transmission of digital voice and data that supports point-to-point and multipoint applications.

In the depicted example, police data processing system 310 (for example, data processing system 200 in FIG. 2) is connected to network 390. In addition, police incident report information 320, police incident locus and canvassing boundary information 330, telephone company blue book information 340, police broadcast message 350, 911 emergency call system information 360, telephone company cellular tower use information 370, and Department of Defense global positioning system information 380 also are connected to network 390. Sources of information 320-380 may be, for example, provided by personal computers or network computers. For purposes of this application, a network computer is any computer, coupled to a network, which receives a program or other application from another computer coupled to the network. In the depicted example, sources of information 320-380 provide data and records for data processing system 310 to perform a quick and automatic canvassing of a crime scene area. Distributed data processing system 300 may include computer servers, additional sources of information, and other devices not shown. In the depicted example, distributed data processing system 300 is the Internet with network 390 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 300 also may be implemented as a number of different types of networks, such as for example, an intranet, a local area network (LAN), or a wide area network (WAN). FIG. 3 is intended as an example, and not as an architectural limitation for the present invention.

Referring now to FIG. 4 a flowchart illustrating a method for automatically canvassing a crime scene investigation area by police in accordance with a preferred embodiment of the present invention is shown. The process may be implemented, for example, in data processing system 200 in FIG. 2. The process begins with a determination whether an incident report, such as, for example, incident report information 320 in FIG. 3 is received by a police data processing system (for example, data processing system 310 in FIG. 3) (Step 410).

The incident report only signifies that a crime has occurred and is merely used to initiate the quick, automatic crime scene canvassing operation by the police data processing system. The only other information that may be contained in the incident report is the type of crime committed. The type of crime may be used as a factor to assist the police data processing system in determining the boundary of the identified crime scene area.

If no incident report is received by the police data processing system the process terminates thereafter (no output of Step 410). If an incident report is received by the police data processing system (yes output of Step 410), then a determination is made as to a locus and a boundary of the crime scene area (Step 420), for example, incident locus and canvassing boundary information 330 in FIG. 3 may be used. The locus is determined by the actual site of the crime and may be utilized in determining the boundary of the crime scene. The boundary surrounds and contains the identified crime scene area. The boundary of the identified crime scene area may be fixed (static) or variable (dynamic) depending on the nature and severity of the crime and if the perpetrator is determined to be “on the move.” Consequently, different crime scene boundaries may vary is size. The locus and boundary determination is for the purpose of quickly and automatically canvassing the area by police looking for witnesses.

In a preferred embodiment of the present invention, the police data processing system may have one or more peripheral nodes connected to it via radio or wireless Internet connection. A node may be a personal digital assistant, laptop computer, or similar device. In this example, the node may have a global position system (GPS) for identifying the exact location of the crime for the police data processing system (for example, Department of Defense global positioning system information 380 in FIG. 3). GPS is a radio navigation system run by the Department of Defense. By triangulation of signals from three of the twenty-four GPS satellites, a receiving unit can pinpoint its current location anywhere on earth to within twenty meters horizontally. In addition, police vehicles may be equipped with GPS receivers that will transmit location of the vehicle to the police data processing system by radio or data link. The police data processing system may use the police vehicle's GPS information to identify the locus of the crime scene.

The node may be placed in a police vehicle. Upon arriving at a crime scene an officer may input the location of the crime into the node to communicate the locus information to the police data processing system if GPS information is not available. The police data processing system's software may set a “standard or logical” initial boundary around the identified crime scene or the officer may manually input a radius into the node to determine the size of the crime scene boundary. Alternatively, an officer may radio a message to a police operator at the police department in order to have the operator input the crime location and boundary information directly into the police data processing system.

Additionally, the police data processing system may be instructed to expand the boundary incrementally up to a predetermined limit over a period of time. Also, the police data processing system may be instructed to expand the originally set boundary if the perpetrator is determined to be mobile. Setting the boundary will determine the canvassing area for the police data processing system.

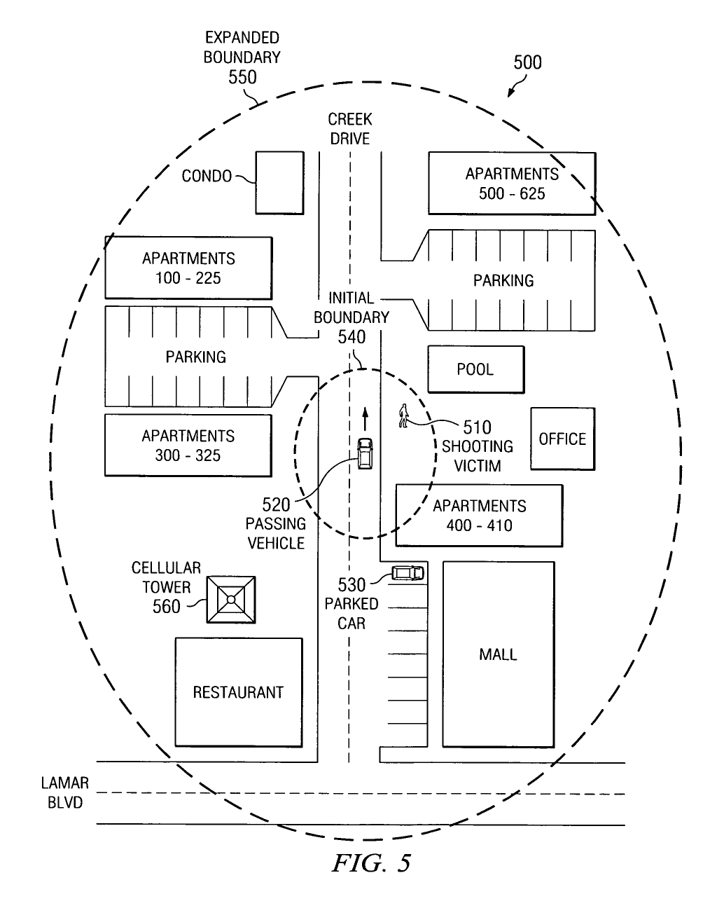

In a preferred embodiment of the present invention, after the police determine the crime scene boundary, the police data processing system uses the incident boundary to compile a list of telephone numbers and addresses from resources like an online telephone blue book database (Step 430), such as, for example, telephone blue book information 340 in FIG. 3. A telephone blue book directory, also known as a reverse telephone directory, lists telephone numbers in either consecutive numerical order or by street address. GPS mapping software compiles a list of addresses within the set canvass operation boundary for the police data processing system (for example, the addresses contained within expanded boundary 550 in FIG. 5). The police data processing system will query the online telephone blue book database in order to compile a list of telephone numbers that correspond with the compiled list of address contained within the crime scene boundary.

In another preferred embodiment of the current invention, the police data processing system may compile a list of cellular telephones using a cellular tower that is located within the crime scene boundary during the time of the incident by requesting the cellular tower logs from the telephone company for that time period (for example, telephone company cellular tower use information 370 in FIG. 3). In yet another preferred embodiment of the present invention, the police data processing system may compile a list of telephones that dialed 911 from within the crime scene boundary during the time of the incident from the emergency system 911 call logs (for example, 911 emergency system information 360 in FIG. 3). The police data processing system will use the compiled telephone numbers to quickly canvass the neighborhood where the incident occurred.

After the police data processing system assembles the list of telephone numbers in Step 430, investigators may record a voice message requesting information with regard to the particular incident they are investigating or they may select a prerecorded message for broadcast by the police data processing system (Step 440) (for example, broadcast message 350 in FIG. 3). In addition, the message selection may include bilingual/multilingual messages. The message is broadcast to the compiled list of telephone numbers contained within the set crime scene boundary for the purpose of finding witnesses quickly.

Subsequent to the telephone list being compiled in Step 430 and the broadcast message being provided in Step 440, in a preferred embodiment of the present invention, the police data processing system initiates telephone calls using a telephone automatic dialer (Step 450) to contact all the telephone numbers compiled in Step 430. Automatic dialing software automatically dials a prerecorded or compiled list of telephone numbers in response to an input signal. Currently, most commercial autodialers have the capability to dial a list of telephone numbers, deliver a recorded message, log responses, and transfer the telephone call to an operator if the call is answered by a human voice.

When the police data processing system makes a telephone connection with one of the compiled telephone numbers in Step 430, the police data processing system will play the broadcast message in Step 440. If the police data processing system detects a response to the broadcast message, then the police data processing system creates a response log (Step 460) listing the telephone number in order for police to call back later. Alternatively, if the police data processing system detects a response to the broadcast message, the police data processing system may transfer the responder to a police operator (similar to the situation where a telephone solicitor will only “pickup” the telephone line when a response is detected on the other end). The process terminates thereafter.

Referring now to FIG. 5, a specific example of an identified police crime scene area is depicted in which a preferred embodiment of the present invention may be implemented. Identified crime scene 500 is the focus of a police investigation to the shooting of victim 510. Initial canvass area boundary 540 (for example, incident locus and canvassing boundary information 330 in FIG. 3) is set up by the officer or dispatcher upon receipt of a telephone call describing the shooting of victim 510 (for example, incident report information 320 in FIG. 3). At the time victim 510 was shot, vehicle 520 (a blue Chevy van) was passing by the scene.

As a result of the police data processing system (for example, data processing system 200 in FIG. 2) quickly and automatically canvassing initial area 540 (for example, Step 450 initiating calls and Step 460 logging responses in FIG. 4), police were able to find two witnesses. One witness was on the balcony of apartment 325 during the time victim 510 was shot. The witness in apartment 325 stated that a blue van (passing vehicle 520) with two males drove north after shooting at a man near the pool (shooting victim 510). A second witness at the pool during the time of the shooting sees a blue truck (passing vehicle 520) leaving the scene.

Neither witness found in the initial canvassing of area 540 were able to provide a license plate number of passing vehicle 520, but told police that the driver was using a cellular telephone. As a result of that particular piece of information, police will search the telephone company's call logs for cellular tower 560 (for example, telephone company cellular tower use information 370 in FIG. 3) during the time victim 510 was shot. By performing the search of the telephone company's call logs for cellular tower 560, police may be able to identify the driver of passing vehicle 520 and check to see if the diver of passing vehicle 520 has information regarding the shooting of victim 510. Also, information obtained from the cellular tower 560 may place the driver of passing vehicle 520 at the scene during the shooting of victim 510 and therefore make him a suspect in the investigation.

Police expand initial boundary 540, to boundary 550, when the original incident went from an officer responding to a dispatch call to a 911 call directed to the command of detectives charged with the investigation regarding the shooting of victim 510. As a result of expanded canvass operation 550, police were able to find two more witnesses. One witness called from the coffee shop in the mall stating that two white men in business suits bought coffee. The witness thought it strange that the two men's dress didn't match the vehicle they drove and that they waited in the vehicle in the adjacent parking lot. The witness also noticed that the vehicle had Nevada license plates. The second witness in apartment 401 noticed a man (shooting victim 510) running toward the pool before hearing the gunshot.

A person in parked car 530 was waiting for shooting victim 510. Immediately after victim 510 was shot, the person in parked car 530 called 911 on a cell phone in order to get an ambulance to the scene but then abruptly disconnected the call. The person in parked car 530 has not contacted police. In this situation, the person in parked car 530 may be identified by police as a witness in one of two ways. Either by searching the telephone company's call log for cellular tower 560, or by searching the 911 emergency system's call log (for example, 911 emergency call system information 360 in FIG. 3) during the time victim 510 was shot.

Thus, the present invention provides a method, apparatus, and computer program product for quickly and automatically canvassing an identified crime scene area for witnesses by police. After receiving an incident report, the locus of the crime scene and its boundary are determined. Telephone calls are made to list of compiled telephone numbers within the boundary of the crime scene area automatically. Then responses to the telephone calls are logged or transferred to a police operator.

An advantage of the present invention is the ability of police to quickly and automatically canvass a crime scene area for witnesses. Police utilizing this automated process to perform canvass operations will save critical time and manpower in solving the crime under investigation. As a result of the quick and automatic canvass operation, police are able to locate witnesses faster. Locating witnesses faster will aid police in resolving the case and apprehending the offender sooner.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for automatically canvassing for witnesses within an identified crime scene area, the method comprising:
determining a boundary for the identified crime scene area;
generating a list of telephone numbers contained within the boundary of the identified crime scene area to form a list of compiled telephone numbers;
initiating a telephone call automatically to each telephone number on the list of compiled telephone numbers; and
logging at least one response to a respective automatically initiated telephone call within the boundary of the identified crime scene area, wherein the identified crime scene area is automatically canvassed.

2. The method of claim 1, wherein the method is initiated upon receipt of an incident report.

3. The method of claim 1, wherein the boundary of the identified crime scene area is determined by a locus.

4. The method of claim 3, wherein the locus of the identified crime scene area is determined by a global positioning system.

5. The method of claim 1, wherein the compiled list of telephone numbers contained within the boundary of the identified crime scene area is queried from at least one of a telephone blue book database, an emergency system 911 call log, and a cellular tower call log.

6. The method of claim 1, wherein the initiating step is performed by a telephone autodialer.

7. The method of claim 6, wherein the telephone autodialer further comprises broadcasting a recorded message upon making a telephone connection with one of the compiled telephone numbers contained within the identified crime area.

8. The method of claim 1, wherein the logging step further comprises transfer of the response to a police operator.

9. A data processing system comprising:
a bus system;
a communication unit connected to the bus system;
a memory connected to the bus system, wherein the memory includes a set of instructions; and
a processing unit connected to the bus system, wherein the processing unit executes the set of instructions to determine a boundary for an identified crime scene area; generate a list of telephone numbers contained within the boundary of the identified crime scene area to form a list of compiled telephone numbers; initiate telephone calls automatically to each telephone number on the list of compiled telephone numbers; and log at least one response to a respective automatically initiated telephone call within the boundary of the identified crime scene area, wherein the identified crime scene area is automatically canvassed.

10. The data processing system of claim 9, wherein the processing unit executes the set of instructions upon receipt of an incident report.

11. The data processing system of claim 9, wherein the boundary of the identified crime scene area is determined by the processing unit further executing the set of instructions to determine a locus.

12. The data processing system of claim 9, wherein the processing unit executes a further set of instructions to query at least one of a telephone blue book database, an emergency system 911 call log, and a cellular tower call log.

13. The data processing system of claim 9, wherein the processing unit executes a further set of instructions to broadcast a recorded message upon making a telephone connection with one of the compiled telephone numbers contained within the identified crime area.

14. The data processing system of claim 9, wherein the processing unit executes a further set of instructions to transfer the response to the automatically initiated telephone call within the boundary of the identified crime scene area to a police operator.

15. A computer program product in a computer-readable medium for automatically canvassing for witnesses within an identified crime scene area, comprising:
first instructions for determining a boundary for the identified crime scene area;
second instructions for generating a list of telephone numbers contained within the boundary of the identified crime scene area to form a list of compiled telephone numbers;
third instructions for initiating a telephone call automatically to each telephone number on the list of compiled telephone numbers contained within the boundary of the identified crime scene area; and
fourth instructions for logging at least one response to a respective automatically initiated telephone call within the boundary of the identified crime scene area, wherein the identified crime scene area is automatically canvassed.

16. The computer program product as recited in claim 15, wherein the first, second, third, and fourth instructions are initiated upon receipt of an incident report.

17. The computer program product as recited in claim 15, wherein the first instructions include first sub-instructions for determining a locus of the identified crime scene area.

18. The computer program product as recited in claim 15, further comprising:
fifth instructions for querying at least one of a telephone blue book database, an emergency system 911 call log, and a cellular tower call log.

19. The computer program product as recited in claim 15, wherein the third instructions include first sub-instructions for broadcasting a recorded message upon making a telephone connection with one of the compiled telephone numbers.

20. The computer program product as recited in claim 15, wherein the fourth instructions include first sub-instructions for transferring the response to a police operator.
